(19) United States
(12) Patent Application Publication
(10) Pub. No.: US 2025/0309506 A1
(43) Pub. Date: Oct. 2, 2025

(54) ALL-SOLID-STATE BATTERY

(71) Applicant: HONDA MOTOR CO., LTD., Tokyo (JP)

(72) Inventor: Akihiro TAGUCHI, Saitama (JP)

(21) Appl. No.: 19/062,061

(22) Filed: Feb. 25, 2025

(30) Foreign Application Priority Data
Mar. 30, 2024 (JP) 2024-058319

(51) Int. Cl. H01M 50/586; H01M 50/474; H01M 50/486

(52) U.S. Cl. CPC H01M 50/586; H01M 50/474; H01M 50/486

(57) ABSTRACT

An all-solid-state battery according to one embodiment of the present invention includes: a positive electrode; a negative electrode; and a solid electrolyte layer laminated between the positive electrode and the negative electrode, in which the positive electrode includes a positive electrode current collector and a positive electrode active material layer formed on a surface of the positive electrode current collector, the positive electrode current collector including a positive electrode current collector extension portion connected to a positive electrode tab, the negative electrode includes a negative electrode current collector, the negative electrode current collector including a negative electrode current collector extension portion connected to a negative electrode tab, at least an end portion of the solid electrolyte layer on a side of the negative electrode current collector extension portion includes an expansion portion expanding to a position beyond an outer periphery of the positive electrode active material layer.

This application is based on and claims the benefit of priority from Japanese Patent Application No. 2024-058319, filed on 30 Mar. 2024, the content of which is incorporated herein by reference.

### BACKGROUND OF THE INVENTION

### Field of the Invention

The present invention relates to an all-solid-state battery.

### Related Art

In recent years, research and development have been conducted on secondary batteries that contribute to energy efficiency, in order to enable more people to access affordable, reliable, sustainable, and advanced energy. Among secondary batteries, the all-solid-state battery with a laminate structure in which a positive electrode current collector, a positive electrode layer, a solid electrolyte layer, a negative electrode layer, and a negative electrode current collector are laminated in this order, is especially noteworthy in terms of the enhanced safety resulting from the non-flammable solid electrolyte, and the higher energy density. In the all-solid-state battery of this laminated structure, a configuration has been known which connects the positive electrode current collector to a positive electrode tab via an extension portion of the positive electrode current collector, and connects the negative electrode current collector to a negative electrode tab via an extension portion of the negative electrode current collector. In such all-solid-state batteries, it has been proposed to arrange an insulating frame around the outer periphery of the positive electrode active material layer of the positive electrode in order to prevent short-circuiting between the positive electrode and the negative electrode inside the battery (Patent Document 1). Furthermore, it has been considered to arrange a porous body between the positive electrode and the negative electrode, the porous body including an electrolyte region in which a solid electrolyte is supported and a non-carrier region in which the solid electrolyte is not supported (Patent Document 2).
Patent Document 1: Japanese Unexamined Patent Application, Publication No. 2023-47083
Patent Document 2: PCT International Publication No. WO 2024/013532

### SUMMARY OF THE INVENTION

Secondary batteries face challenges in increasing capacity and suppressing short-circuiting between the positive electrode and the negative electrode. In order to address the high-capacity needs of all-solid-state batteries, consideration has been given to all-solid-state lithium batteries that use lithium ions as a charge transfer medium, in which lithium in the positive electrode layer is deposited on the negative electrode layer during charging, and lithium in the negative electrode layer is occluded in the positive electrode layer during discharging. All-solid-state lithium batteries change in thickness of the negative electrode layer during charging and discharging. Therefore, the positive electrode current collector extension portion and the negative electrode current collector extension portion are preferably capable of deformation in response to the changes in thickness of the negative electrode layer. However, deformation of the negative electrode current collector extension portion in response to the changes in thickness of the negative electrode layer may lead to short-circuiting between the negative electrode current collector extension portion and the positive electrode current collector. Moreover, in a case where manufacturing variations cause the negative electrode current collector extension portion and the positive electrode current collector to be arranged close to each other immediately after production, external vibrations may lead to short-circuiting between the negative electrode current collector extension portion and the positive electrode current collector.

The present invention has been made in view of the above circumstances, and aims to provide an all-solid-state battery, in which the negative electrode current collector extension portion that connects the negative electrode current collector to the negative electrode tab is less likely to short-circuit with the positive electrode current collector.

The inventors of the present invention have found that the above problems can be solved by a feature whereby the end portion of the solid electrolyte layer on the negative electrode current collector extension portion side includes an expansion portion expanding to a position beyond the outer periphery of the positive electrode active material layer, and the expansion portion includes an insulating base material, thereby arriving at completion of the present invention. Thus, the present invention provides the following.

(1) An all-solid-state battery includes: a positive electrode; a negative electrode; and a solid electrolyte layer laminated between the positive electrode and the negative electrode, in which the positive electrode includes a positive electrode current collector and a positive electrode active material layer formed on a surface of the positive electrode current collector, the positive electrode current collector including a positive electrode current collector extension portion connected to a positive electrode tab, the negative electrode includes a negative electrode current collector, the negative electrode current collector including a negative electrode current collector extension portion connected to a negative electrode tab, at least an end portion of the solid electrolyte layer on a side of the negative electrode current collector extension portion includes an expansion portion expanding to a position beyond an outer periphery of the positive electrode active material layer, the expansion portion includes an insulating base material, an insulating frame is provided around the outer periphery of the positive electrode active material layer, the expansion portion expands to a position beyond an outer periphery of the insulating frame, and at least part of the expansion portion is supported by the insulating frame.

According to the all-solid-state battery as described in (1), the end portion of the solid electrolyte layer on the negative electrode current collector extension portion side includes an expansion portion expanding to a position beyond the outer periphery of the positive electrode active material layer, and the expansion portion includes an insulating base material; therefore, shape stability is enhanced. Consequently, even when the thickness of the negative electrode changes during charging and discharging, the negative electrode current collector extension portion and the positive electrode current collector are less likely to short-circuit. There is no particular need to interpose an insulating base material in a portion where the positive electrode active material layer of the positive electrode faces the negative electrode in the solid electrolyte layer. By not interposing an insulating base material, the charge transfer medium (lithium ions) is more likely to be conducted than the case of interposing an insulating base material. Since the insulating frame is arranged at the outer periphery of the positive electrode active material layer, the positive electrode current collector extension portion and the negative electrode current collector are less likely to short-circuit, even if the positive electrode current collector extension portion deforms toward the negative electrode current collector side. Additionally, at least part of the expansion portion is supported by the insulating frame, thereby further enhancing the shape stability of the expansion portion.

(2) In the all-solid-state battery as described in (1), the length of a portion of the expansion portion extending beyond the outer periphery of the insulating frame is greater than the combined thickness of the positive electrode active material layer and the positive electrode current collector.

According to the all-solid-state battery as described in (2), the length of the portion of the expansion portion extending beyond the outer periphery of the insulating frame is the length as described above, thereby further reducing the likelihood of short-circuiting between the negative electrode current collector extension portion and the positive electrode current collector.

(3) In the all-solid-state battery as described in (1) or (2), at least a portion of the expansion portion extending beyond the outer periphery of the insulating frame consists solely of the insulating base material.

According to the all-solid-state battery as described in (3), voids are less likely to be formed in the solid electrolyte layer of the expansion portion.

(4) In the all-solid-state battery as described in any one of (1) to (3), the expansion portion includes a mixed portion where the insulating base material is supported by the solid electrolyte layer, and a unitary portion consisting solely of the insulating base material.

According to the all-solid-state battery as described in (4), the insulating base material is supported by the solid electrolyte layer in the mixed portion, thereby stabilizing the shape of the unitary portion of the insulating base material.

(5) In the all-solid-state battery as described in any one of (1) to (4), the insulating base material is a nonwoven fabric.

According to the all-solid-state battery as described in (5), the nonwoven fabric has a textured surface with high affinity for materials forming the solid electrolyte layer, thereby enhancing the strength of the expansion portion.

(6) An all-solid-state battery includes: a positive electrode; a negative electrode; and a solid electrolyte layer laminated between the positive electrode and the negative electrode, in which the positive electrode includes a positive electrode current collector and a positive electrode active material layer formed on a surface of the positive electrode current collector, the positive electrode current collector including a positive electrode current collector extension portion connected to a positive electrode tab, the negative electrode includes a negative electrode current collector, the negative electrode current collector including a negative electrode current collector extension portion connected to a negative electrode tab, at least an end portion of the solid electrolyte layer on a side of the negative electrode current collector extension portion includes an expansion portion expanding to a position beyond an outer periphery of the positive electrode active material layer, the expansion portion includes an insulating base material, part of the insulating base material is supported by the solid electrolyte layer, and the rest is a unitary portion consisting solely of the insulating base material.

According to the all-solid-state battery as described in (6), the insulating base material included in the expansion portion expanding beyond the outer periphery of the positive electrode active material layer is partially supported by the solid electrolyte layer, while the remaining part is a unitary portion consisting solely of the insulating base material, thereby reducing the likelihood of void formation in the solid electrolyte layer and stabilizing the shape of the unitary portion of the insulating base material. Consequently, even when the thickness of the negative electrode changes during charging and discharging, the negative electrode current collector extension portion and the positive electrode current collector are less likely to short-circuit. There is no particular need to interpose an insulating base material in a portion where the positive electrode contacts the negative electrode in the solid electrolyte layer. By not interposing an insulating base material, the charge transfer medium (lithium ions) is more likely to be conducted than the case of interposing an insulating base material.

The present invention has been made in view of the above circumstances, and aims to provide an all-solid-state battery that reduces the likelihood of short-circuiting between the negative electrode current collector extension portion and the positive electrode current collector.

### BRIEF DESCRIPTION OF THE DRAWINGS

FIG. 1 is a plan view illustrating an all-solid-state battery according to a first embodiment of the present invention;

FIG. 2 is a cross-sectional view along the line II-II in FIG. 1;

FIG. 3 is a cross-sectional view along the line III-III in FIG. 1;

FIG. 4A is an enlarged view of a main part of FIG. 2;

FIG. 4B is a plan view of the solid electrolyte layer illustrated in FIG. 4A;

FIG. 5A is an enlarged cross-sectional view of a main part of an all-solid-state battery according to a second embodiment of the present invention;

FIG. 5B is a plan view of the solid electrolyte layer illustrated in FIG. 5A;

FIG. 6A is an enlarged cross-sectional view of a main part of an all-solid-state battery according to a third embodiment of the present invention; and

FIG. 6B is a plan view of the solid electrolyte layer illustrated in FIG. 6A.

### DETAILED DESCRIPTION OF THE INVENTION

Hereinafter, embodiments of the present invention will be described with reference to the drawings. However, the embodiments described below are merely illustrative and do not limit the scope of the present invention.

### First Embodiment

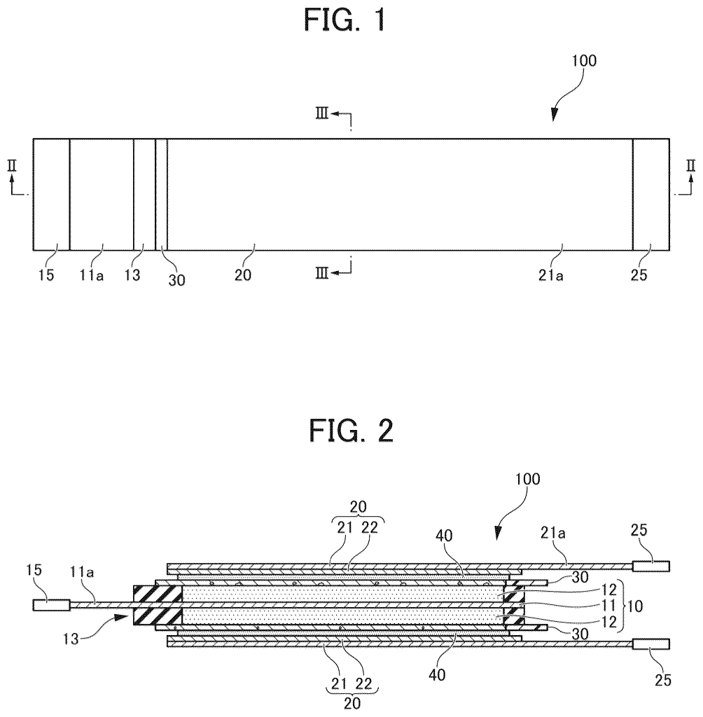

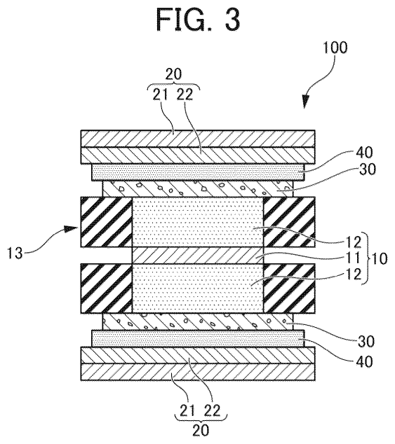

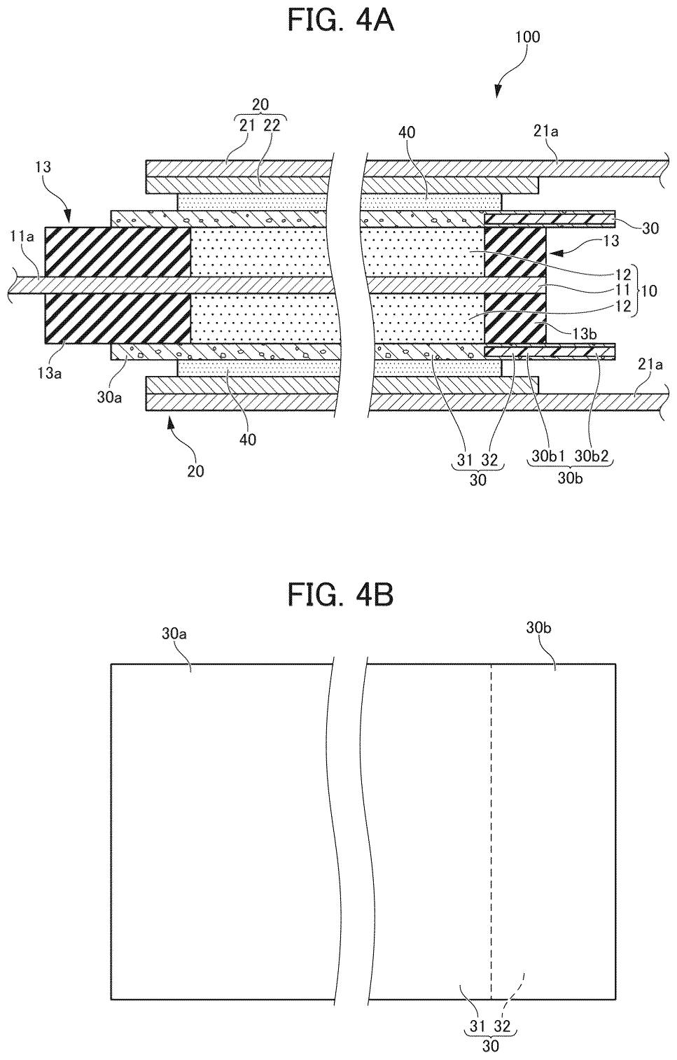

FIG. 1 is a plan view illustrating an all-solid-state battery according to a first embodiment of the present invention. FIG. 2 is a cross-sectional view along the line II-II in FIG. 1; FIG. 3 is a cross-sectional view along the line III-III in FIG. 1; FIG. 4A is an enlarged view of a main part of FIG. 2; and FIG. 4B is a plan view of the solid electrolyte layer illustrated in FIG. 4A.

As illustrated in FIGS. 1 to 4B, an all-solid-state battery 100 includes a positive electrode 10, a negative electrode 20, and a solid electrolyte layer 30 laminated between the positive electrode 10 and the negative electrode 20. The negative electrode 20 and the solid electrolyte layer 30 are laminated so as to sandwich a single positive electrode 10. An intermediate layer 40 is arranged between the negative electrode 20 and the solid electrolyte layer 30.

The positive electrode 10 includes a positive electrode current collector 11 and positive electrode active material layers 12 formed on both surfaces of the positive electrode current collector 11. The positive electrode current collector 11 includes a positive electrode current collector extension portion 11a, which connects to the positive electrode tab 15. The positive electrode current collector extension portion 11a does not include a positive electrode active material layer 12 formed thereon. An insulating frame 13 is arranged around the outer periphery of the positive electrode active material layer 12. The edge of the insulating frame 13b on the negative electrode current collector extension portion 21a side aligns with the edge of the positive electrode current collector 11. The insulating frame 13a on the positive electrode current collector extension portion 11a side is wider than the insulating frame 13b on the negative electrode current collector extension portion 21a side. The width of the insulating frame 13a on the positive electrode current collector extension portion 11a side may be longer than the total thickness of the positive electrode active material layer 12, the solid electrolyte layer 30, the intermediate layer 40, and the negative electrode 20. When the width of the insulating frame 13a exceeds the total thickness described above, the positive electrode current collector extension portion 11a and the negative electrode 20 become less likely to short-circuit, even if the positive electrode current collector extension portion 11a deforms. The width of the insulating frame 13a may be no more than twice the total thickness.

The negative electrode 20 includes a negative electrode current collector 21 and a metal layer 22 laminated on the solid electrolyte layer 30 side of the negative electrode current collector 21. The negative electrode current collector 21 includes a negative electrode current collector extension portion 21a that connects to the negative electrode tab 25. The metal layer 22 is not laminated on the negative electrode current collector extension portion 21a. The edge on the positive electrode current collector extension portion 11a side of the negative electrode current collector 21 does not extend beyond the insulating frame 13a on the positive electrode current collector extension portion 11a side. Thus, the edge on the positive electrode current collector extension portion 11a side of the negative electrode current collector 21 is less likely to short-circuit with the positive electrode current collector extension portion 11a.

The solid electrolyte layer 30 includes expansion portions 30a and 30b that expand beyond the outer periphery of the positive electrode active material layer 12. The expansion portion 30a on the positive electrode current collector extension portion 11a side extends beyond the edge on the positive electrode current collector extension portion 11a side of the negative electrode current collector 21. The expansion portion 30b on the negative electrode current collector extension portion 21a side extends beyond the outer periphery of the insulating frame 13b on the negative electrode current collector extension portion 21a side. The inner portion 30b1 of the expansion portion 30b, located more inward than the outer periphery of the insulating frame 13b, is supported by the insulating frame 13b on the negative electrode current collector extension portion 21a side. The outer portion 30b2 of the expansion portion 30b, extending beyond the outer periphery of the insulating frame 13b, protects the positive electrode current collector 11 so as to prevent short-circuiting between the negative electrode current collector extension portion 21a and the positive electrode current collector 11, when the negative electrode current collector extension portion 21a deforms toward the positive electrode 10 side. The length of the outer portion 30b2 may be greater than the total thickness of the positive electrode active material layer 12 and the positive electrode current collector 11. When the length of the outer portion 30b2 exceeds the total thickness, short-circuiting between the negative electrode current collector extension portion 21a and the positive electrode current collector 11 becomes even less likely. The length of the outer portion 30b2 may also be no more than twice the total thickness.

The portion of the solid electrolyte layer 30 that contacts the positive electrode 10 is formed by a solid electrolyte composition 31. In the present embodiment, the expansion portion 30a on the positive electrode current collector extension portion 11a side is also formed by the solid electrolyte composition 31. The expansion portion 30b on the negative electrode current collector extension portion 21a side contains an insulating base material 32. The insulating base material 32 is embedded within the solid electrolyte composition 31. The inclusion of the insulating base material 32 in the expansion portion 30b allows for improving the shape stability of the expansion portion 30b, and reducing the deformation of the negative electrode current collector extension portion 21a toward the positive electrode current collector 11 side of the positive electrode 10.

The following materials are examples of the positive electrode current collector 11, the positive electrode active material layer 12, the positive electrode tab 15, the negative electrode current collector 21, the metal layer 22, the negative electrode tab 25, the solid electrolyte composition 31, the insulating base material 32, and the intermediate layer 40, in the case where the all-solid-state battery 100 is an all-solid-state lithium battery that uses lithium ions as a charge transfer medium.

The positive electrode current collector 11 is not particularly limited in material or shape so long as having a function as a current collector for the positive electrode 10. Examples of materials for the positive electrode current collector 11 include aluminum, aluminum alloy, stainless steel, nickel, iron, and titanium, in which aluminum, aluminum alloy, and stainless steel are preferred. Examples of the shape of the positive electrode current collector 11 include foil and plate.

The positive electrode active material layer 12 contains at least one type of positive electrode active material. There is no particular limitation on the positive electrode active material, and may be any materials commonly used for positive electrode layers in solid-state secondary batteries. For example, layered active materials containing lithium, spinel-type active materials, and olivine-type active materials can be used. Specific examples of positive electrode active materials include lithium cobalt oxide (LiCoO₂), lithium nickel oxide (LiNiO₂), LiNiₚMn_{q}CoᵣO₂ (where p+q+r=1), LiNiₚAl_{q}CoᵣO₂ (where p+q+r=1), lithium manganese oxide (LiMn₂O₄), heteroelement-substituted Li—Mn spinel such as Li₁₊ₓMn_{2-x-y}MO₄ (where x+y=2, and M is at least one element selected from Al, Mg, Co, Fe, Ni, and Zn), lithium titanate (an oxide containing Li and Ti), and lithium metal phosphate (LiMPO₄, where M is at least one element selected from Fe, Mn, Co, and Ni).

The positive electrode active material layer 12 may optionally contain a solid electrolyte to improve lithium-ionic conductivity. A conductive additive may be optionally contained to improve electrical conductivity. A binder may be optionally contained to impart flexibility or other properties. The solid electrolyte, the conductive additive, and the binder are not particularly limited, and may be any materials commonly used for positive electrode layers in all-solid-state lithium batteries.

The material for the positive electrode tab 15 may be the same as the material for the positive electrode current collector 11, or may be different from the material for the positive electrode current collector 11. The positive electrode tab 15 may be integrally connected to the positive electrode current collector 11.

The negative electrode current collector 21 is not particularly limited in material or shape so long as having a function as a current collector for the negative electrode 20. Examples of materials for the negative electrode current collector 21 include nickel, copper, and stainless steel. Examples of the shape of the negative electrode current collector 21 include foil and plate.

The metal layer 22 is not particularly limited in material or shape so long as having a function of allowing lithium ions to densely deposit thereon. The metal layer 22 may be a metallic lithium layer or a layer of a metal that forms an alloy with lithium. Examples of metals that form alloys with lithium include Mg, Si, Au, Ag, In, Ge, Sn, Pb, Al, and Zn.

The metal forming the metal layer 22 may be in the form of powder or a thin film. By employing the negative electrode 20 including the metal layer 22, a uniform lithium deposition layer can be formed on the surface of the metal layer 22.

The material for the negative electrode tab 25 may be the same as the material for the negative electrode current collector 21, or may be different from the material for the negative electrode current collector 21.

The solid electrolyte composition 31 contains a solid electrolyte. The solid electrolyte is not particularly limited so long as having lithium ion conductivity; however, examples include sulfide solid electrolytes, oxide solid electrolytes, nitride solid electrolytes, and halide solid electrolytes. Examples of sulfide solid electrolytes include Li₂S—P₂S₅ and Li₂S—P₂S₅—LiI. The sulfide solid electrolyte may have an argyrodite-type crystal structure. Examples of oxide solid electrolytes include NASICON-type oxides, garnet-type oxides, and perovskite-type oxides. An example of a NASICON-type oxide is an oxide containing Li, Al, Ti, P, and O (e.g., Li_{1.5}Al_{0.5}Ti_{1.5}(PO₄)₃). An example of a garnet-type oxide is an oxide containing Li, La, Zr, and O (e.g., Li₇La₃Zr₂O₁₂). An example of a perovskite-type oxide is an oxide containing Li, La, Ti, and O (e.g., LiLaTiO₃).

The solid electrolyte composition 31 may contain a binder. There are no specific restrictions on the binder, and materials commonly used in the solid electrolyte layer of solid-state secondary batteries may be employed.

The insulating base material 32 may be a sheet or a porous material. Examples of materials that can be used for the insulating base material 32 include organic or inorganic materials. Examples of organic materials include resin sheets, woven fabrics, and nonwoven fabrics. An example of an inorganic material is a ceramic sheet. Nonwoven fabrics have many surface irregularities and high affinity with the solid electrolyte composition 31, thereby enhancing the strength of the expansion portion 30b.

The intermediate layer 40 may serve to improve the uniformity of lithium ion deposition on the metal layer 22 of the negative electrode 20. The intermediate layer 40 may have electronic conductivity and include pores through which lithium ions can pass. The intermediate layer 40 may contain a material with lithium metal conductivity and an electron-conductive material. Examples of materials with lithium metal conductivity include amorphous carbon particles. Examples of amorphous carbon particles include types of carbon black such as acetylene black, furnace black, Ketjen black, as well as coke, activated carbon, CNT (carbon nanotubes), fullerenes, and graphene. The electron-conductive material that can be used is, for example, a metal. The metal may be a metal in particle form. Examples of metals include Ag, Au, Pt, Pd, Si, Al, Bi, Sn, Zn, Ga, and In.

The all-solid-state battery 100 of the present embodiment, configured as described above, includes the expansion portion 30b on the edge on the negative electrode current collector extension portion 21a side of the solid electrolyte layer 30, in which the expansion portion 30b expands beyond the outer periphery of the positive electrode active material layer 12, and the expansion portion 30b contains the insulating base material 32, thereby providing high shape stability. Therefore, even if the thickness of the negative electrode 20 changes during charging and discharging, short-circuiting between the negative electrode current collector extension portion 21a and the positive electrode current collector 11 is less likely. An insulating base material does not need to be interposed in a portion of the solid electrolyte layer 30 where the positive electrode active material layer 12 of the positive electrode 10 faces the negative electrode 20. When an insulating base material is interposed, the conduction of the charge transfer medium (lithium ions) is obstructed. Therefore, by not interposing an insulating base material, the charge transfer medium is more easily conducted, compared to the case of interposing an insulating base material. Accordingly, an insulating base material is preferably not interposed in a portion where the positive electrode active material layer 12 faces the negative electrode 20. Additionally, since the insulating frame 13 is arranged around the outer periphery of the positive electrode active material layer 12, deformation of the positive electrode current collector extension portion 11a toward the negative electrode current collector 21 side is less likely to short-circuit with the negative electrode current collector 21. Furthermore, the inner portion 30b1 of the expansion portion 30b is supported by the insulating frame 13b, thereby further improving the shape stability of the expansion portion 30a.

### Second Embodiment

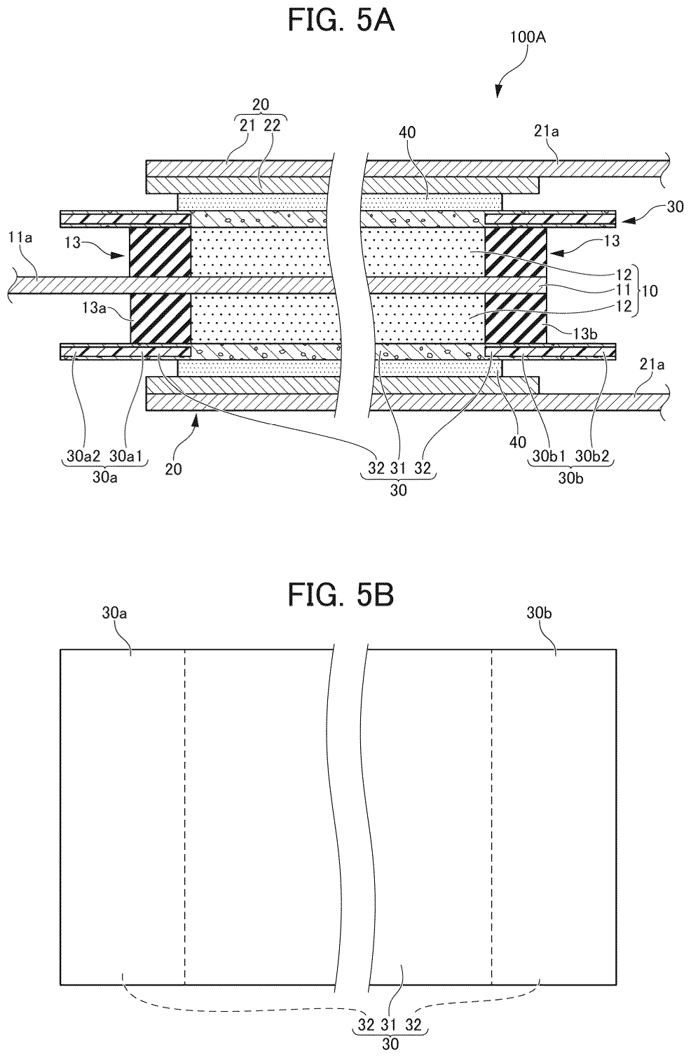

FIG. 5A is an enlarged cross-sectional view of a main part of an all-solid-state battery according to a second embodiment of the present invention, and FIG. 5B is a plan view of the solid electrolyte layer illustrated in FIG. 5A.

As illustrated in FIG. 5A, an all-solid-state battery 100A according to the present embodiment differs from the all-solid-state battery 100 of the first embodiment in terms of the configuration of the insulating frame 13. As illustrated in FIGS. 5A and 5B, the configuration of the solid electrolyte layer 30 in the all-solid-state battery 100A also differs from that of the all-solid-state battery 100 of the first embodiment. Since the other configurations are the same as those of the all-solid-state battery 100 of the first embodiment, the same reference numbers are assigned to the same components, and descriptions thereof are omitted.

As for the insulating frame 13 of the all-solid-state battery 100A of the present embodiment, the width of the insulating frame 13a on the positive electrode current collector extension portion 11a side is the same as that of the insulating frame 13b on the negative electrode current collector extension portion 21a side. The expansion portion 30a on the positive electrode current collector extension portion 11a side of the solid electrolyte layer 30 extends beyond the outer periphery of the insulating frame 13a on the positive electrode current collector extension portion 11a side. The expansion portion 30a on the positive electrode current collector extension portion 11a side contains the insulating base material 32. The insulating base material 32 is embedded within the solid electrolyte composition 31. The length of the outer portion of the expansion portion 30a, which extends beyond the outer periphery of the insulating frame 13a, may be greater than the total thickness of the intermediate layer 40 and the negative electrode 20. When the length of the outer portion of expansion portion 30a is longer than this total thickness, short-circuiting between the positive electrode current collector extension portion 11a and the negative electrode 20 becomes less likely, even if the positive electrode current collector extension portion 11a deforms. The length of the outer portion of the expansion portion 30a may be no more than twice the total thickness.

The expansion portion 30a on the positive electrode current collector extension portion 11a side contains the insulating base material 32. The insulating base material 32 is embedded within the solid electrolyte composition 31 The inclusion of the insulating base material 32 in the expansion portion 30a allows for improving the shape stability of the expansion portion 30a, and reducing the likelihood of deformation of the negative electrode current collector extension portion 21a toward the negative electrode 20 side.

The all-solid-state battery 100A of the present embodiment, configured as described above, includes the expansion portion 30b containing the insulating base material 32, whereby the negative electrode current collector extension portion 21a and the positive electrode current collector 11 are less likely to short-circuit, even if the thickness of the negative electrode 20 changes during charging and discharging, similarly to the all-solid-state battery 100 of the first embodiment. Furthermore, in the all-solid-state battery 100A of the present embodiment, the width of the insulating frame 13a and the width of the insulating frame 13b are the same, allowing for a reduction in the size of the battery.

### Third Embodiment

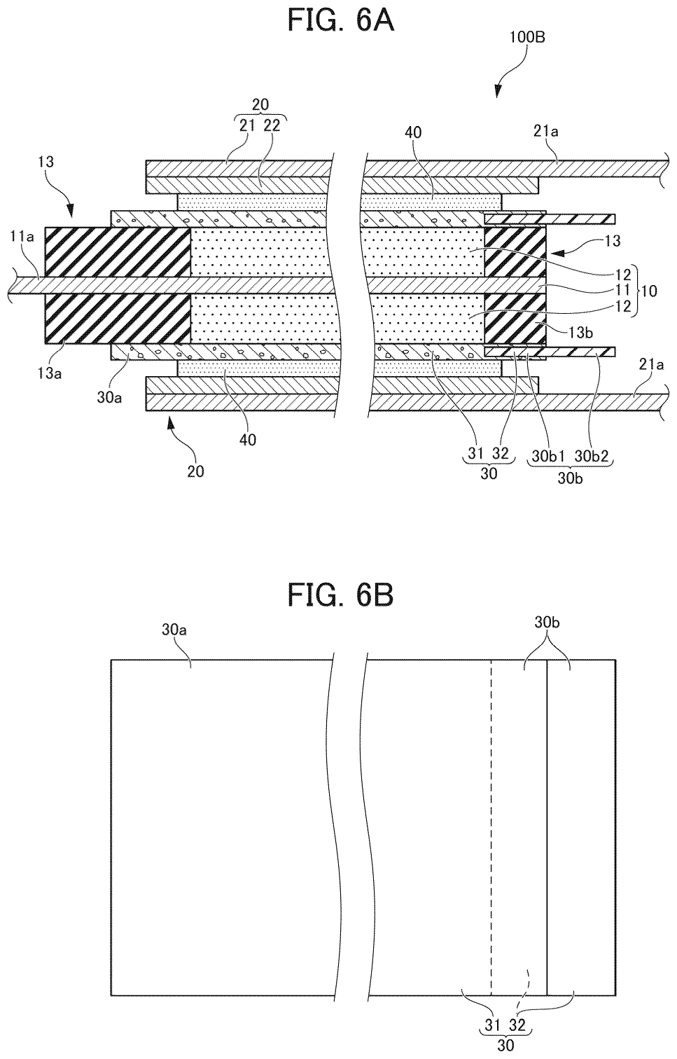

FIG. 6A is an enlarged cross-sectional view of a main part of an all-solid-state battery according to a third embodiment of the present invention, and FIG. 6B is a plan view of the solid electrolyte layer illustrated in FIG. 6A.

As illustrated in FIGS. 6A and 6B, the all-solid-state battery 100B differs from the all-solid-state battery 100 of the first embodiment in terms of the shape of the expansion portion 30b on the negative electrode current collector extension portion 21a side of the solid electrolyte layer 30. Since the other configurations are the same as those of the all-solid-state battery 100 of the first embodiment, the same reference numbers are assigned to the same components, and descriptions thereof are omitted.

In the present embodiment, the inner portion 30bl of expansion portion 30b on the negative electrode current collector extension portion 21a side forms a mixed portion, in which the insulating base material 32 is embedded within the solid electrolyte composition 31, and the insulating base material 32 is supported by the solid electrolyte layer 30. The outer portion 30b2 of the expansion portion 30b is a unitary portion that consists solely of the insulating base material 32.

The all-solid-state battery 100B of the present embodiment, configured as described above, includes the expansion portion 30b containing the insulating base material 32, whereby the negative electrode current collector extension portion 21a and the positive electrode current collector 11 are less likely to short-circuit, even if the thickness of the negative electrode 20 changes during charging and discharging, similarly to the all-solid-state battery 100 of the first embodiment. Furthermore, in the all-solid-state battery 100B of the present embodiment, the width of the insulating frame 13a and the width of the insulating frame 13b are the same, allowing for a reduction in the size of the battery. The outer portion 30b2 of the expansion portion 30b is a unitary portion that consists solely of the insulating base material 32, whereby voids are less likely to occur in the solid electrolyte of the solid electrolyte layer. Additionally, the inner portion 30b1 of the expansion portion 30b is the mixed portion, in which the insulating base material 32 is supported by the solid electrolyte layer 30, thereby stabilizing the shape of the unitary portion of the insulating base material.

The embodiments of the present invention have been described above; however, the present invention is not limited to the above embodiments. For example, the insulating frame 13 is arranged around the outer periphery of the positive electrode active material layer 12 in each of the all-solid-state batteries 100, 100A, and 100B of the embodiments; however, the insulating frame 13 may be omitted.

### EXPLANATION OF REFERENCE NUMERALS

10: positive electrode
11: positive electrode current collector
11a: positive electrode current collector extension portion
12: positive electrode active material layer
13: insulating frame
15: positive electrode tab
20: negative electrode
21: negative electrode current collector
21a: negative electrode current collector extension portion
22: metal layer
25: negative electrode tab
30: solid electrolyte layer
30a, 30b: expansion portion
31: solid electrolyte composition
32: insulating base material
40: intermediate layer
100, 100A, 100B: all-solid-state battery

What is claimed is:

1. An all-solid-state battery, comprising:
a positive electrode; a negative electrode; and a solid electrolyte layer laminated between the positive electrode and the negative electrode, wherein
the positive electrode includes a positive electrode current collector and a positive electrode active material layer formed on a surface of the positive electrode current collector, the positive electrode current collector including a positive electrode current collector extension portion connected to a positive electrode tab,
the negative electrode includes a negative electrode current collector, the negative electrode current collector including a negative electrode current collector extension portion connected to a negative electrode tab,
at least an end portion of the solid electrolyte layer on a side of the negative electrode current collector extension portion includes an expansion portion expanding to a position beyond an outer periphery of the positive electrode active material layer,
the expansion portion includes an insulating base material,
an insulating frame is provided around the outer periphery of the positive electrode active material layer,
the expansion portion expands to a position beyond an outer periphery of the insulating frame, and
at least part of the expansion portion is supported by the insulating frame.

2. The all-solid-state battery according to claim 1, wherein a length of a portion of the expansion portion extending beyond the outer periphery of the insulating frame is greater than a combined thickness of the positive electrode active material layer and the positive electrode current collector.

3. The all-solid-state battery according to claim 1, wherein at least a portion of the expansion portion extending beyond the outer periphery of the insulating frame consists solely of the insulating base material.

4. The all-solid-state battery according to claim 1, wherein the expansion portion includes a mixed portion where the insulating base material is supported by the solid electrolyte layer, and a unitary portion consisting solely of the insulating base material.

5. The all-solid-state battery according to claim 1, wherein the insulating base material is a nonwoven fabric.

6. An all-solid-state battery, comprising:
a positive electrode; a negative electrode; and a solid electrolyte layer laminated between the positive electrode and the negative electrode, wherein
the positive electrode includes a positive electrode current collector and a positive electrode active material layer formed on a surface of the positive electrode current collector, the positive electrode current collector including a positive electrode current collector extension portion connected to a positive electrode tab,
the negative electrode includes a negative electrode current collector, the negative electrode current collector including a negative electrode current collector extension portion connected to a negative electrode tab,
at least an end portion of the solid electrolyte layer on a side of the negative electrode current collector extension portion includes an expansion portion expanding to a position beyond an outer periphery of the positive electrode active material layer, and
the expansion portion includes an insulating base material, including a mixed portion where the insulating base material is supported by the solid electrolyte layer and a unitary portion consisting solely of the insulating base material.
